(19) United States
(12) Patent Application Publication
(10) Pub. No.: US 2010/0192189 A1
(43) Pub. Date: Jul. 29, 2010

(54) APPARATUS AND METHOD FOR SHARING BROADCASTING PROGRAM

(75) Inventors: Sang-Kwon Lee, Suwon-si (KR); O-Hoon Kwon, Suwon-si (KR); Sung-Bin Im, Yongin-si, (KR); Hyok-Sung Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si, (KR)

(21) Appl. No.: 12/670,059

(22) PCT Filed: Aug. 13, 2008
(86) PCT No.: PCT/KR08/04716

§ 371 Date: Jan. 21, 2010

Related U.S. Application Data
(60) Provisional application No. 60/956,201, filed on Aug. 16, 2007.

(30) Foreign Application Priority Data
Dec. 13, 2007 (KR) 10-2007-0130070

(51) Int. Cl. H04N 7/173

(52) U.S. Cl. 725/93

(57) ABSTRACT

Provided are an apparatus and method for sharing a broadcasting program, and more particularly, an apparatus and method for sharing a broadcasting program via the Internet. The apparatus includes a list manager which manages a list of devices storing a broadcasting program and a device information transmitter which transmits information, to a first device, about a second device storing a broadcasting program requested by the first device, wherein the second device divides the requested broadcasting program into time slots and transmits each time slot to the first device.

### TECHNICAL FIELD

The present invention relates to an apparatus and method for sharing a broadcasting program, and more particularly, to an apparatus and method for sharing a broadcasting program via the Internet.

### BACKGROUND ART

In order to record a desired broadcasting program, users generally use TVs or set-top-boxes (STBs) having a personal video recorder (PVR) function to preset the recording of a desired broadcasting program or record a current broadcasting program.

Recently, the emergence of TVs or STBs supporting an Internet function has allowed users to record broadcasting programs being delivered through broadcast stations as well as download broadcasting programs that have not been recorded via the Internet from providers contracted with broadcast stations to provide broadcasting programs being delivered over broadcast channels to users.

In order to view broadcasting programs being delivered through a broadcast station, conventionally, users had to record a desired program directly through a TV or STB having a PVR function. Users were also allowed to download only some of the terrestrial broadcasting programs supplied under a contract between a broadcaster and a service provider from the service provider. Furthermore, in this case, if a multitude of TVs and STBs are simultaneously connected to the contracted service provider for downloading a specific broadcasting program, a load on a provider's server may increase. Due to increased load and limited network bandwidth, the service provider had to provide only Standard Definition (SD) broadcasting programs to users instead of High Definition (HD) programs.

### DISCLOSURE OF INVENTION

### Technical Problem

Thus, there is an urgent need for a method for sharing a broadcasting program among a large number of TVs and STBs connected via the Internet by using peer-to-peer (P2P) technology which allows the TVs and STBs to download a desired broadcasting program via the Internet as fast as possible while reducing a server load.

The Japanese Patent Laid-open Publication No. 2006-190205 describes that a main processor shared by a plurality of network devices converts between protocols operating in heterogeneous networks and collects and updates metadata for specific content. The plurality of network devices are connected via a virtual P2P network, or are connected to each other via P2P connections. However, the above-cited reference does not propose a method for providing a fast download while reducing a server load by allowing multiple TVs and STBs connected via the Internet to share a broadcasting program using P2P networking.

### Technical Solution

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

Specifically, exemplary embodiments of the present invention provide a method and apparatus for allowing multiple devices connected via the Internet and having a broadcasting program recording function to share broadcasting programs stored therein, which can provide a fast download of broadcasting programs and reduce a server load.

According to an aspect of the present invention, there is provided an apparatus for sharing a broadcasting program, comprising a list manager which manages a list of devices storing a broadcasting program and a device information transmitter which transmits information, to a first device about a second device storing a broadcasting program requested by the first device, wherein the second device divides the requested broadcasting program into time slots and transmits each time slot to the first device.

According to another aspect of the present invention, there is provided an apparatus for sharing a broadcasting program, the apparatus comprising an information transmitter which divides information about a stored broadcasting program into time slots and which transmits information about each time slot to a unit which manages devices that store the broadcasting program, a broadcasting program requester which requests information about a device storing a broadcasting program selected by a user from the unit, and a broadcasting program receiver which receives the requested device information and receiving the selected broadcasting program from the device indicated by the received device information.

According to still another aspect of the present invention, there is provided a method for sharing a broadcasting program, the method comprising managing a list of devices storing a broadcasting program, and transmitting information, to a first device, about a second device storing a broadcasting program requested by the first device to the first device, wherein the second device divides the requested broadcasting program into time slots and transmits each time slot to the first device.

According to yet another aspect of the present invention, there is provided a method for sharing a broadcasting program, the method comprising dividing information about a stored broadcasting program into time slots and transmitting information about each time slot to a unit which manages devices that store the broadcasting program, requesting information about a device storing a broadcasting program selected by a user from the unit, and receiving the requested device information and then the selected broadcasting program from the device indicated by the received device information.

### BRIEF DESCRIPTION OF THE DRAWINGS

FIG. 1 is a block diagram of an apparatus for sharing a broadcasting program according to an exemplary embodiment of the present invention;

FIG. 2 is a block diagram of the second server in the apparatus of FIG. 1;

FIG. 3 is a block diagram of the first device in the apparatus of FIG. 1;

FIG. 4 is a block diagram of a method for managing a list in a second server according to an exemplary embodiment of the present invention;

FIG. 5 is a flowchart illustrating a method for sharing a broadcasting program according to an exemplary embodiment of the present invention; and

FIG. 6 is a schematic diagram illustrating a synchronization process according to an exemplary embodiment of the present invention.

### MODE FOR THE INVENTION

Features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of an apparatus and method for sharing a broadcasting program according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks.

These computer program instructions may also be stored in a computer usable or computer-readable memory that can direct a computer or other programmable data processing apparatus to function in a particular manner, such that the instructions implement the function specified in the flowchart block or blocks.

The computer program instructions may also be loaded onto a computer or other programmable data processing apparatus to cause a series of operational steps to be performed on the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in the reverse order, depending on the functionality involved.

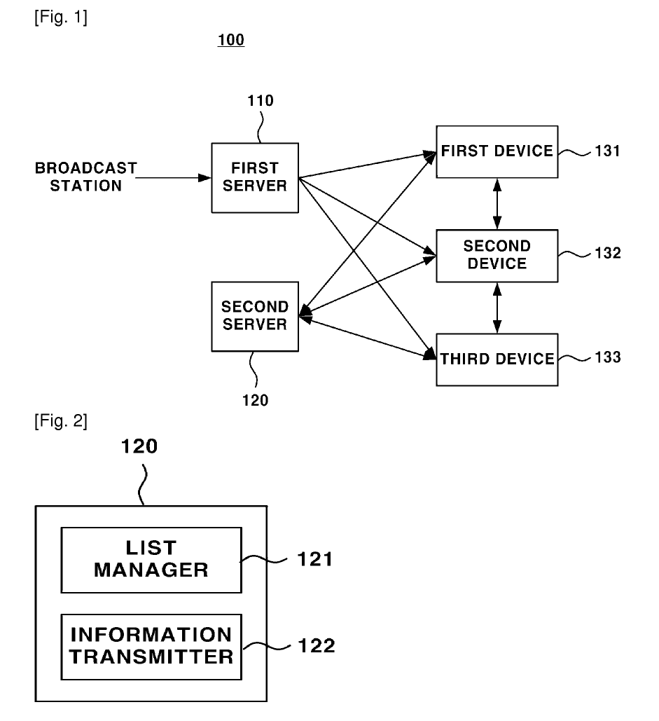

FIG. 1 is a block diagram of an apparatus 100 for sharing a broadcasting program according to an exemplary embodiment of the present invention.

Referring to FIG. 1, the apparatus 100 according to the current embodiment includes a first server 110, a second server 120 and a plurality of devices 131 through 133, all of which can be connected via a network such as the Internet. While in the present exemplary embodiment, the network is the Internet, the network is not limited thereto, and may be various wired and wireless networks. The plurality of devices 131 through 133 may be Internet-enabled TVs and STBs having a personal video recorder (PVR) function.

The first server 110 stores metadata corresponding to information about broadcasting programs provided by a broadcast station, etc., and transmits the stored metadata to the plurality of devices 131 through 133. While in the present exemplary embodiment, the first server 110 stores and transmits the metadata to the plurality of devices 131 through 133, it may also delete the metadata after transmission to the plurality of devices 131 through 133.

The metadata provided by a broadcast station includes, but is not limited to, program ID, title, genre, cast, broadcast time data such as start time and end time, and access information, such as a Uniform Resource Locator (URL) for the second server 120, which is required for the plurality of devices 131 through 133 to access the second server 120.

The second server 120 manages a list of devices storing a specific broadcasting program and time information about the broadcasting program stored in each device in the list. Device information stored on the second server 120 may include, but is not limited to, IP addresses of devices that can identify the devices. Thus, if one of the plurality of devices 131 through 133 makes a request for a specific broadcasting program, the second server 120 may transmit information about devices storing the specific broadcasting program and time information about the broadcasting program stored in each of the devices to the requesting device. The plurality of devices 131 through 133 are hereinafter respectively referred to as a first device 131, a second device 132, and a third device 133.

Although FIG. 1 shows that the apparatus 100 includes one second server 120, the number of the second server 120 may be greater than one. If only one second server 120 exists for managing a list of devices for all broadcasting programs, a load on the second server 120 will increase because the second server 120 needs to handle all requests from the first through third devices 131 through 133 for broadcasting programs. Using a plurality of second servers 120 allows separate management of devices for each broadcasting program, thus reducing the load on the second servers 120. In this case, the first through third devices 131 through 133 may request a desired broadcasting program from a second server designated for the desired broadcasting program.

If a plurality of second servers 120 exist, access information required to access the second servers 120 is used for the first through third devices 131 through 133 to identify a second server for managing a list of devices storing a specific broadcasting program.

That is, the first through third devices 131 through 133 use access information such as URL received from the first server 110 to determine one of the plurality of second servers 120 managing a list of devices storing a specific broadcasting program, from which the first through third devices 131 through 133 request the specific broadcasting program.

Referring to FIG. 2, the second server 120 includes a list manager 121 managing a list of devices holding a specific broadcasting program and an information transmitter 122 transmitting a list of devices storing a specific broadcasting program to a device that makes a request for the specific broadcasting program.

When one of the first through third devices 131 through 133 records or deletes a broadcasting program, the list manager 121 manages a list of devices based on received broadcasting program information such as program ID and time information. For example, if one of the first through third devices 131 through 133 records a broadcasting program, the one of the first through third devices 131 through 133 transmits information such as ID and time information of the broadcasting program being recorded to the second server 120. The list manager 121 updates a list of devices based on the broadcasting program ID and time information. The device recording the broadcasting program may also transmit ID information such as IP address and MAC address so that the second server 120 can identify the device. Similarly, when one of the first through third devices 131 through 133 deletes a recorded broadcasting program, the list manager 121 updates a list of devices based on broadcasting program ID and time information received from the device deleting the broadcasting program.

The information transmitter 122 transmits a list of devices storing a specific broadcasting program to a device that makes a request for the specific broadcasting program. For example, if the first device 131 requests “broadcasting program A” and the second and third devices 132 and 133 store “broadcasting program A”, the information transmitter 122 transmits information indicating that the second and third devices 132 and 133 store the “broadcasting program A” to the first device 131 based on a list of devices managed by the list manager 121.

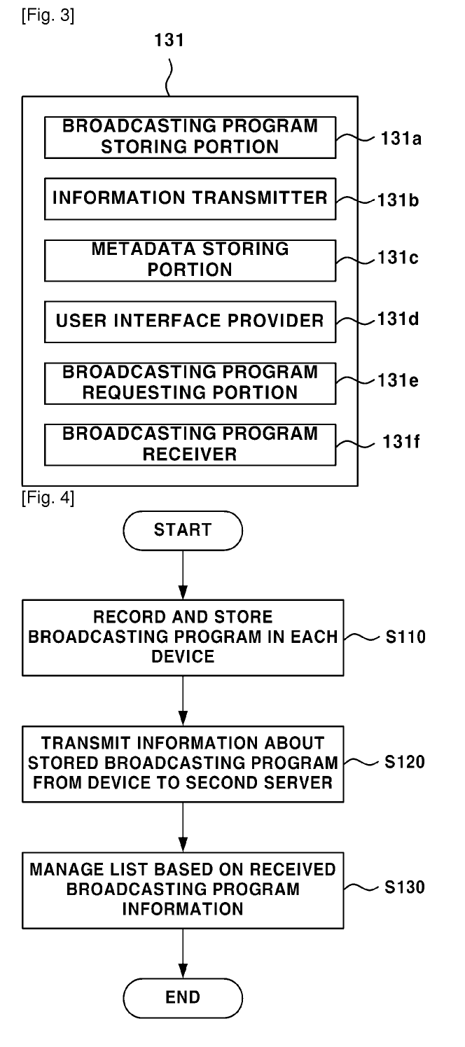

FIG. 3 is a block diagram of the first device 131 in the apparatus 100 of FIG. 1. Since the second and third devices 132 and 133 also have the same configuration and functions as the first device 131, the second and third devices 132 and 133 are understood to include the same elements as shown in FIG. 3.

Referring to FIG. 3, the first device 131 includes a broadcasting program storing portion 131a storing a specific broadcasting program, an information transmitting portion 131b transmitting information about the stored broadcasting program such as broadcasting program ID and time information to the second server 120, a metadata storing portion 131c storing metadata received from the first server 110, a user interface provider 131d providing a user interface that enables a user to select his/her desired broadcasting program based on the stored metadata, a broadcasting program requesting portion 131e requesting a broadcasting program from the second server 120 if the broadcast program selected by a user through a provided user interface does not exist in the broadcasting program storing portion 131a, and a broadcasting program receiver 131f requesting a broadcasting program from a device identified by device information received from the second server 120 and receiving the broadcasting program.

More specifically, the broadcasting program storing portion 131a stores broadcasting programs being delivered through a broadcast station using a preset recording or immediate recording function supported by the first device 131 or delete some of the stored broadcasting programs according to a user's command or when there is insufficient storage space.

If storing or deleting a broadcasting program in or from the broadcasting program storing portion 131a causes a change in information about the broadcasting programs stored in the broadcasting program storing portion 131a, the information transmitting portion 131b transmits the change information to the second server 120 that will then updates a list of devices storing the broadcasting program.

The user interface providing portion 131d provides a user interface such as an Electronic Program Guide (EPG), which enables a user to select his/her desired broadcasting program. The user interface providing portion 131d creates a user interface based on metadata, i.e., information about broadcasting programs stored in the metadata storing portion 131c and provides the user interface to the user. For example, the user interface providing portion 131d may provide an EPG with broadcasting programs arranged according to at least one of channel, genre, and time based on the metadata.

The user can select a desired broadcasting program through the provided user interface. If the broadcasting program selected by the user has been stored in the broadcasting program storing portion 131a, the broadcasting program requesting portion 131e plays back the broadcasting program. If not, the broadcasting program requesting portion 131e requests the selected broadcasting program from the second server 120.

Based on information about devices received from the second server in response to the request from the broadcasting program requesting portion 131e, the broadcasting program receiver 131f receives the broadcasting program from device(s) that has (have) stored the broadcasting program.

For example, if the first device 131 requests a broadcasting program from the second server 120 and the second and third devices 132 and 133 store the requested broadcasting program, the second server 120 may transmit information about the second and third devices to the first device 131.

Thus, the first device 131 receives the broadcasting program from the second and third devices 132 and 133. The second and third devices 132 and 133 may store a wholly or partially recorded broadcast program. If the second or third device 132 or 133 stores a part of the broadcasting program that is recorded at the middle thereof, a synchronization problem may occur when the first device 132 receives the broadcasting program from the second and third devices 132 and 133.

To overcome the synchronization problem, the first through third devices 131 through 133 may divide the broadcasting program stored therein into broadcasting time slots based on start time and end time of the broadcasting program and transmit information about each time slot to the second server 120. Thus, the second server 120 is able to manage a list of devices for each time slot that is obtained by dividing the broadcasting program based on the broadcast time. For example, if the broadcasting program is broadcast from 7:00 PM till 8:00 PM and the duration of a time slot is 1 minute, the first through third devices 131 through 133 divide the broadcasting program into one-minute time slots. If one of the first through third devices 131 through 133 starts and finishes the recording of a broadcast program at 7:20:30 PM and 8:00 PM, respectively, the device may divide the duration of broadcasting program from 7:21 PM to 8:00 PM into one-minute time slots except for a 30-second time interval from 7:20:30 PM to 7:21 PM.

Thus, because a device requesting a broadcasting program is able to receive the broadcasting program from other devices in time slots, synchronization can be prevented. The synchronization of a time slot can be performed using an I-frame in a program ID that is extracted from Program and System Information Protocol (PSIP) information. Synchronization is not limited thereto, and can be performed using other various methods. The broadcasting program receiver 131f adjusts overlapping time slots of the broadcasting program so that the broadcasting program storing portion 131a stores the received broadcasting program.

FIG. 4 is a block diagram of a method for managing a list in the second server 120 according to an exemplary embodiment of the present invention.

Referring to FIGS. 1 and 4, each of the first through third devices 131 through 133 records a broadcasting program desired by a user using preset recording, etc., based on metadata received from the first server 110, and stores the recorded broadcasting program (S110). In this case, each of the first through third devices 131 through 133 may record all or a part of broadcasting program at any point.

After recording the broadcasting programs, the first through third devices 131 through 133 transmit IDs of the recorded broadcasting programs and time information such as recording start time and end time to the second server 120 (S120). In this case, one or a plurality of second servers 120 may be provided for the respective broadcasting programs. If a plurality of second servers 120 are provided, each of the first through third devices 131 through 133 is able to select a second server 120 to which information about each broadcasting program will be sent using access information regarding the second server 120 contained in the metadata.

The second server 120 creates a list of devices storing each broadcasting program based on the information received from the first through third devices 131 through 133 for management (S130). For example, the second server 120 may create and manage a list containing devices holding a broadcasting program and time information about the broadcasting program. Each time a change is made to broadcasting programs stored in each of the first through third devices 131 through 133, the above steps S110 through S130 can be performed so as to update the list.

Although FIG. 4 shows creation and management of a list for recorded broadcasting programs, the method can be applied similarly to deletion of the previously stored broadcasting programs from a device.

More specifically, if a broadcasting program is deleted from a device, the second server 120 may update a created list based on broadcasting program ID and time information received from the device.

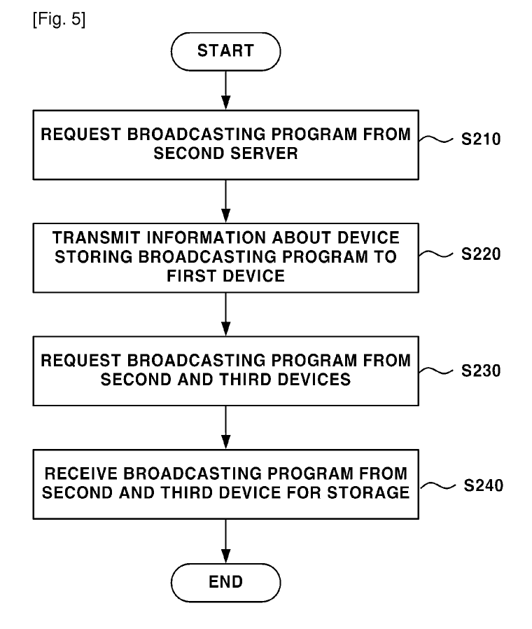

FIG. 5 is a flowchart illustrating a method for sharing a broadcasting program according to an exemplary embodiment of the present invention. It is assumed in FIG. 5 that the first device 131 requests a broadcasting program from the second server 120 and the second and third devices 132 and 133 store the requested broadcasting program.

Referring to FIGS. 1, 2 and 5, if the first device 131 does not hold a broadcasting program selected by a user, the first device 131 requests the broadcasting program from the second server 120 (S210). The request can be made based on metadata received from the first server 110, i.e., using access information related to the second server 120 that manages a list of devices storing the broadcasting program.

The information transmitter 122 of the second server 120 transmits information about devices storing requested broadcasting program and time information about the broadcasting program stored in the devices to the first server 131 (S220). In the present exemplary embodiment, it is assumed that the second and third devices 132 and 133 store parts of the requested broadcasting program.

The first device 131 requests a broadcasting program from the second and third devices 132 and 133 based on the device information and time information received from the second server 120 (S230). The first device 131 then receives the broadcasting program from the second and third devices 132 and 133 for storage (S240).

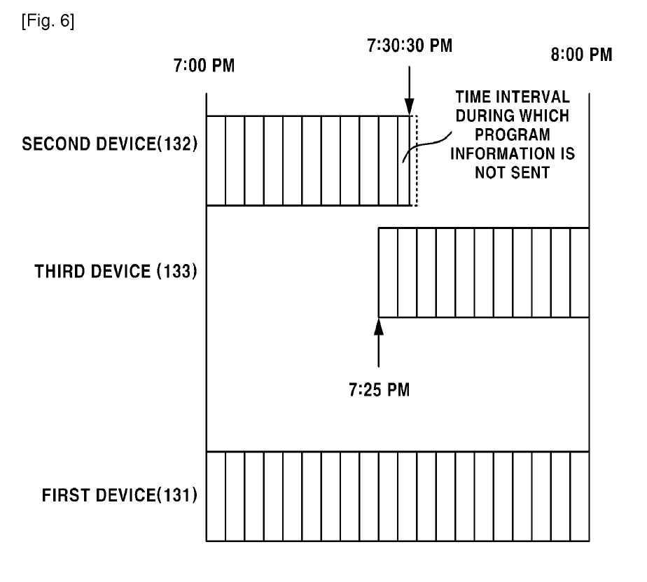

FIG. 6 is a schematic diagram illustrating a synchronization process according to an exemplary embodiment of the present invention. It is assumed that the first device 131 requests a broadcasting program and the second and third devices 132 and 133 store the requested broadcasting program and the duration of a time slot is 1 minute.

Referring to FIG. 6, when the second device 132 records a part of broadcasting program that is broadcast from 7:00 PM to 7:30:30 PM and the third device 133 records a part of broadcasting program that is broadcast from 7:25 PM to 8:00 PM, the second and third devices 132 and 133 divide their recorded parts of the broadcasting program into time slots for transmission to the second server 120 except for a time interval corresponding to a part of broadcasting program recorded by the second device 132 from 7:30 PM to 7:30:30 PM. That is, the second device 132 does not transmit broadcasting program information for the time interval from 7:30 PM to 7:30:30 PM to the second server 120.

Further, because the first device 131 receives a broadcasting program from the second and third devices 132 and 133 at regular time slots of one minute duration, a synchronization problem can be prevented.

Meanwhile, the term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

### INDUSTRIAL APPLICABILITY

Based on the foregoing, an apparatus and method for sharing a broadcasting program have at least one of the following advantages over conventional techniques.

The present invention provides a fast download of previous broadcast broadcasting programs via a network.

The present invention also uses a P2P technology to suppress an increase of a load on a server of a service provider providing broadcasting programs.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

1. An apparatus for sharing a broadcasting program, comprising:
a list manager which manages a list of devices storing a broadcasting program; and
a device information transmitter which transmits information, to a first device, about a second device storing a broadcasting program requested by the first device,
wherein the second device divides the requested broadcasting program into time slots and transmits each time slot to the first device.

2. The apparatus of claim 1, wherein upon recording or deleting a broadcasting program, each of the first and second devices transmits information about the broadcasting program being recorded or deleted to the list manager.

3. The apparatus of claim 2, wherein information about the broadcasting program includes an ID of the broadcasting program being recorded or deleted and time information.

4. An apparatus for sharing a broadcasting program, the apparatus comprising:
an information transmitter which divides information about a stored broadcasting program into time slots and which transmits information about each time slot to a unit managing devices that store the broadcasting program;
a broadcasting program requester which requests information about a device storing a broadcasting program selected by a user from the unit; and
a broadcasting program receiver which receives the requested device information and which receives the selected broadcasting program from the device indicated by the received device information.

5. The apparatus of claim 4, wherein the information transmitter transmits an ID of the broadcasting program being recorded or deleted and time information to the unit.

6. The apparatus of claim 4, wherein the information transmitter divides the broadcasting program into time slots based on stored start time and end time of the broadcasting program.

7. The apparatus of claim 4, wherein the broadcasting program receiver receives each time slot obtained by dividing the selected broadcasting program from the device indicated by the device information received upon a request from the broadcasting program requester.

8. The apparatus of claim 4, further comprising:
a metadata storing unit which stores metadata related to the broadcasting program, for selecting the broadcasting program desired by the user; and
a user interface provider which provides a user interface for selecting the broadcasting program to the user based on the metadata.

9. The apparatus of claim 8, wherein the metadata includes broadcasting program ID, start time and end time, title, genre, cast, and access information required to access the unit which manages devices that store the broadcasting program.

10. The apparatus of claim 9, wherein the broadcasting program requester requests information about devices storing the selected broadcasting program from a unit that is predesignated for each broadcasting program based on the access information.

11. The apparatus of claim 9, wherein the information transmitter transmits the information about the stored broadcasting program to the predesignated unit for each broadcasting program based on the access information.

12. A method for sharing a broadcasting program, the method comprising:
managing a list of devices storing a broadcasting program; and
transmitting information, to a first device, about a second device storing a broadcasting program requested by the first device,
wherein the second device divides the requested broadcasting program into time slots and transmits each time slot to the first device.

13. The method of claim 12, wherein the managing of the list of devices comprises, upon recording or deleting a broadcasting program from each of the first and second devices, receiving information about the broadcasting program being recorded or deleted.

14. The method of claim 13, wherein information about the broadcasting program includes an ID of the broadcasting program being recorded or deleted and time information.

15. A method for sharing a broadcasting program, the method comprising:
dividing information about a stored broadcasting program into time slots and transmitting information about each time slot to a unit which manages devices that store the broadcasting program;
requesting information about a device storing a broadcasting program selected by a user from the unit; and
receiving the requested device information and then the selected broadcasting program from the device indicated by the received device information.

16. The method of claim 15, wherein the transmitting of the information about each time slot to the unit comprises transmitting an ID of the broadcasting program being recorded or deleted and time information.

17. The method of claim 15, wherein the transmitting of the information about each time slot to the unit comprises dividing the broadcasting program into time slots based on start time and end time of the stored broadcast program.

18. The method of claim 17, wherein the receiving of the broadcasting program comprises receiving the selected broadcasting program in time slots from the device indicated by the device information.

19. The method of claim 15, further comprising:
storing metadata related to the broadcasting program, for selecting the broadcasting program desired by the user; and
providing a user interface to the user based on the metadata, for selecting the broadcasting program.

20. The method of claim 19, wherein the metadata includes broadcasting program ID, start time and end time, title, genre, cast, and access information required to access the unit managing devices storing the broadcasting program.

21. The method of claim 20, wherein the requesting of information about devices storing the selected broadcasting program comprises requesting information about devices storing the selected broadcasting program from a unit that is predesignated for each broadcasting program based on the access information.

22. The method of claim 20, wherein the transmitting of the information about the broadcasting program to the unit comprises transmitting information about the stored broadcasting program to the predesignated unit for each broadcasting program based on the access information.
